(19) United States
(12) Patent Application Publication
(10) Pub. No.: US 2019/0202999 A1
(43) Pub. Date: Jul. 4, 2019

(54) COMPOSITE POLYMER GRANULE COMPOSITION AND METHOD OF MAKING

(71) Applicants: Dow Global Technologies LLC, Midland, MI (US); Rohm and Haas Company, Collegville, PA (US)

(72) Inventors: Liang Chen, Sewickley, PA (US); Carl W. Reinhardt, Kawkawlin, MI (US); Wei Gao, Fort Washington, PA (US)

(21) Appl. No.: 16/325,968

(22) PCT Filed: Sep. 19, 2017
(86) PCT No.: PCT/US2017/052216

§ 371 Date: Feb. 15, 2019

Related U.S. Application Data
(60) Provisional application No. 62/400,242, filed on Sep. 27, 2016.

(51) Int. Cl. C08J 3/12; C08J 3/07; C08L 23/02; C08L 33/08

(52) U.S. Cl. CPC C08J 3/126; C08J 3/07; C08L 23/02; C08L 33/08; C08L 2201/54; C08L 2205/025; C08L 2205/03; C08L 2205/035; C08L 2207/53

(57) ABSTRACT

A method for preparing an aqueous dispersion, the method comprising: melt-kneading a non-functionalized polyolefin (co)polymer, a modified-polyolefin copolymer, a surfactant and water to provide an aqueous dispersion, the average diameter of solids in the aqueous dispersion are less than 400 nm; and neutralizing the aqueous dispersion with a base to a pH of 5 or greater.

A method for preparing a composite polymer granule, the method comprising: providing the aqueous dispersion described herein; combining a (meth)acrylic monomer and an initiator with the aqueous dispersion under emulsion polymerization conditions.

A composite polymer granule comprising: a core defined by a non-functionalized polyolefin (co)polymer and a modified polyolefin copolymer, wherein the modified-polyolefin copolymer includes, in polymerized form, monomer units selected from acidic monomers and olefinic monomers.

### BACKGROUND

Waterborne polyolefin dispersions have been used to prepare hybrid materials, for example, composite polymer granules. Composite polymer granules have been demonstrated which are a polyolefin-acrylic hybrid. Such hybrids have had a relatively high T_{g}, for example, 80° C. It is desired to prepare a polyolefin-acrylic hybrid having a low T_{g}, for example, at or below 50° C. Having a lower T_{g} allows the hybrid to be used as a binder. Acrylic materials are commonly used as binders, and a composite polymer granule having a low T_{g} is a candidate to replace acrylic materials in a variety of applications. The polyolefin portion of the composite polymer granule provides improved hydrophobicity as compared to a purely acrylic system, thereby providing improved water resistance.

### SUMMARY

A method for preparing an aqueous dispersion, the method comprising: melt-kneading a non-functionalized polyolefin (co)polymer, a modified-polyolefin copolymer, a surfactant and water to provide an aqueous dispersion, the average diameter of solids in the aqueous dispersion are less than 400 nm; and neutralizing the aqueous dispersion with a base to a pH of 5 or greater.

A method for preparing a composite polymer granule, the method comprising: providing the aqueous dispersion prepared in any one of claim 1 or 2; combining a (meth)acrylic monomer and an initiator with the aqueous dispersion under emulsion polymerization conditions, the (meth)acrylic monomer is added such that a ratio of the combination of the non-functionalized polyolefin (co)polymer and the modified-polyolefin copolymer to the (meth)acrylic monomer is from 20:1 to 1:2 by weight.

A composite polymer granule comprising: a core defined by a non-functionalized polyolefin (co)polymer and a modified polyolefin copolymer, wherein the modified-polyolefin copolymer includes, in polymerized form, monomer units selected from acidic monomers and olefinic monomers wherein the ratio of acidic monomers to olefinic monomers is from 0.5 wt % to 20 wt %; a shell defined by a (meth)acrylic copolymer having a Tg of less than 50° C.; and wherein the ratio of the combination of the non-functionalized polyolefin (co)polymer and the modified-polyolefin copolymer to (meth)acrylic copolymer is from 20:1 to 1:2 by weight.

### DETAILED DESCRIPTION

The present disclosure describes a composite polymer granule and a method of making the same. The composite polymer granule is prepared from an aqueous dispersion. The composite polymer granule is defined by a core, defined broadly as the combination of a non-functionalized polyolefin (co)polymer and a modified polyolefin copolymer, and a shell, defined broadly as a (meth)acrylic copolymer. The composite polymer granule composition is prepared by the emulsion polymerization of the aqueous dispersion and a (meth)acrylic monomer in the presence of an initiator. The composite polymer granule and method of making the same are described in greater detail herein. A method for making the aqueous dispersion is also described in greater detail herein.

As used herein “(co)polymer” refers to a homopolymer or a copolymer.

As used herein “(meth)acrylic” refers to acrylic, methacrylic and combinations thereof. Optionally, the acrylic or methacrylic is further substituted.

The core of the composite polymer granule is defined by the combination of a non-functionalized polyolefin (co)polymer and a modified-polyolefin copolymer. As used herein, “non-functionalized” means the absence of a reactive polar group on the (co)polymer. As used herein, “modified-polyolefin copolymer” means at least some of the acid groups of the polyolefin copolymer are neutralized with a neutralization agent.

The non-functionalized polyolefin (co)polymer is prepared from one or more olefin monomers. In one instance, the non-functionalized polyolefin (co)polymer is a homopolymer. In one instance, the non-functionalized polyolefin (co)polymer is a copolymer.

The modified polyolefin copolymer includes in polymerized form one or more olefin monomers and one or more acidic monomers, wherein the ratio of acidic monomers to olefinic monomers is from 0.5wt % to 20 wt %. In one instance, the ratio of acidic monomers to olefinic monomers is from is from 0.75 wt % to 15 wt %. In one instance, the ratio of acidic monomers to olefinic monomers is from is from 1.0 wt % to 10 wt %. The modified polyolefin copolymer is partially or fully neutralized by a neutralizing agent.

Examples of monomers suitable for use in preparing the non-functionalized polyolefin (co)polymer include, but are not limited to, one or more alpha-olefins such as ethylene, propylene, 1-butene, 3-methyl-1-butene, 4-methyl-1-pentene, 3-methyl-1-pentene, 1-heptene, 1-hexene, 1-octene, 1-decene, and 1-dodecene. Examples of non-functionalized polyolefin(co)polymers include, but are not limited to, polyethylene, polypropylene, poly-1-butene, poly-3-methyl-1-butene, poly-3-methyl-1-pentene, poly-4-methyl-1-pentene, ethylene-propylene copolymer, ethylene-1-butene copolymer, and propylene-1-butene copolymer; copolymers (including elastomers) of an alpha-olefin with a conjugated or non-conjugated diene, as typically represented by ethylene-butadiene copolymer and ethylene-ethylidene norbornene copolymer; and polyolefins (including elastomers) such as copolymers of two or more alpha-olefins with a conjugated or non-conjugated diene, as typically represented by ethylene-propylene-butadiene copolymer, ethylene-propylene-dicyclopentadiene copolymer, ethylene-propylene-1,5-hexadiene copolymer, and ethylene-propylene-ethylidene norbornene copolymer; ethylene-vinyl compound copolymers such as ethylene-vinyl acetate copolymer, ethylene-vinyl alcohol copolymer, ethylene-vinyl chloride copolymer, ethylene acrylic acid or ethylene-(meth)acrylic acid copolymers, and ethylene-(meth)acrylate copolymer. These (co)polymers may be used either alone or in combinations of two or more.

In some embodiments, exemplary olefinic polymers used in the non-functionalized polyolefin (co)polymer include homogeneous polymers, such as, high density polyethylene (HDPE), heterogeneously branched linear low density polyethylene (LLDPE); heterogeneously branched ultra-low linear density polyethylene (ULDPE); homogeneously branched, linear ethylene/alpha-olefin copolymers; homogeneously branched, substantially linear ethylene/alpha-olefin polymers; and high pressure, free radical polymerized ethylene polymers and copolymers such as low density polyethylene (LDPE) or ethylene vinyl acetate polymers (EVA). In other embodiments, the olefinic polymers used in the non-functionalized polyolefin (co)polymer include, ethylene-methyl acrylate (EMA) based polymers. In other particular embodiments, the ethylene-alpha olefin copolymer may, for example, be ethylene-butene, ethylene-hexene, or ethylene-octene copolymers or interpolymers. In other particular embodiments, the propylene-alpha olefin copolymer may, for example, be a propylene-ethylene or a propylene-ethylene-butene copolymer or interpolymer.

The non-functionalized polyolefin (co)polymer has a melt flow rate in the range of from 1 to 1500 g/10 minutes, measured in accordance with ASTM D-1238 (at 190° C./2.16 Kg). All individual values and subranges from 1 to 1500 g/10 minutes are included herein and disclosed herein; for example, the melt flow rate can be from a lower limit of 1 g/10 minutes, 2 g/10 minutes, 3 g/10 minutes, 4 g/10 minutes, 5 g/10 minutes 100 g/10 minutes, 200 g/10 minutes, 500 g/10 minutes, 800 g/10 minutes, 1000 g/10 minutes, 1300 g/10 minutes; or 1400 g/10 minutes to an upper limit of 1500 g/10 minutes, 1250 g/10 minutes, 1000 g/10 minutes, 800 g/10 minutes, 500 g/10 minutes, 100 g/10 minutes, 50 g/10 minutes, 40 g/10 minutes, and 30 g/10 minutes. For example, the propylene/alpha-olefin copolymer may have a melt flow rate in the range of from 1 to 1500 g/10 minutes; or from 1 to 500 g/10 minutes; or from 500 to 1500 g/10 minutes; or from 500 to 1250 g/10 minutes; or from 300 to 1300 g/10 minutes; or from 5 to 30 g/10 minutes.

The aqueous dispersion described herein includes the non-functionalized polyolefin (co)polymer described herein and a modified-polyolefin copolymer. In one instance, the modified-polyolefin copolymer is a maleic anhydride functionalized polyethylene, such as high density polyethylene. Maleic anhydride functionalized polyethylene copolymers, terpolymers and blends may also be used. Maleic anhydride functionality can be incorporated into the polymer by grafting or other reaction methods. When grafting, the level of maleic anhydride incorporation is typically below 10 percent by weight based on the weight of the polymer. Examples of commercially available maleic anhydride functionalized polyethylene include those available under the tradename AMPLIFY™ available from The Dow Chemical Company, such as AMPLIFY™ GR-204 and Affinity™ GA 1000R. Other examples of maleic anhydride functionalized polyethylene are available under the trade name FUSABOND™ available from El. du Pont de Nemours and Company. Other maleic anhydride grafted polyethylene polymers, copolymers, and terpolymers may include POLYBOND™ available from Chemtura, PLEXAR™ from Lyondell Chemical Company, and LOTADER™ from ARKEMA.

In one instance, the modified-polyolefin copolymers include, but are not limited to, unsaturated cyclic anhydrides and their aliphatic diesters, and the diacid derivatives. For example, maleic anhydride and compounds selected from C₁-C₁₀ linear and branched dialkyl maleates, C₁-C₁₀ linear and branched dialkyl fumarates, itaconic anhydride, C₁-C₁₀ linear and branched itaconic acid dialkyl esters, maleic acid, fumaric acid, itaconic acid, and combinations thereof. Commercially available examples of polymeric coupling agents include, but are not limited to, polymers available under the trade name LICOCENE® from Clariant Corporation, such as LICOCENE® PE MA, which is a maleic anhydride modified polyethylene wax; polymers under the trade name A-C™ Performance Additives from Honeywell Corporation, such as AC-575™ which is an ethylene maleic anhydride copolymer, and AC-392™ and AC-395™ which are high density oxidized polyethylene; products under the trade name CERAMER from Baker Hughes Company, such as CERAMER 1608; PA-18 polyanhydride copolymer from Chevron-Phillips Company, EXXELOR™ from ExxonMobil Chemical Company; and Epolene from Westlake Chemical Company.

In one instance, the modified-polyolefin copolymer has an acid number of less than 200, in another instance, less than 100, in another instance less than 50. Acid number can be determined by ASTM D-1386. Acid number can refer to an amount of KOH in mg KOH/g polymer required to neutralize acid functionality when measured by titration.

In one instance, the modified-polyolefin copolymer is partially neutralized with a neutralizing agent. In one instance, the neutralizing agent is added after the aqueous dispersion is prepared. In one instance, the neutralizing agent is added prior to formation of the aqueous dispersion. In one instance, the neutralizing agent is added during the formation of the aqueous dispersion. Examples of suitable neutralizing agents include NaOH, KOH or a volatile base. As used herein a “volatile base” is a base that can be evaporated (conversion of a liquid to a gas or vapor) at a temperature in a range from about 100° C. to about 200° C. at a pressure in a range of about 1 atmosphere. Examples of such a volatile base include, but are not limited to, N,N-dimethylethanolamine (DMEA), ammonia, hydrazine, methylamine, ethylamine, diethylamine, triethylamine, isobutylamine, N,N-diisopropylethylamine, morpholine, piperazine, ethylenediamine, and 1,4-diazabicyclo[2.2.2]octane), and mixtures thereof.

The aqueous dispersion described herein includes a surfactant. Examples of the surfactant include, but are not limited to, cationic surfactants, anionic surfactants, non-ionic surfactants, and combinations thereof. Examples of anionic surfactants include, but are not limited to, sulfonates, carboxylates, and phosphates. Examples of cationic surfactants include, but are not limited to, quaternary amines Examples of non-ionic surfactants include, but are not limited to, block copolymers containing ethylene oxide and silicone surfactants. The stabilizing agent can include an external surfactant and/or an internal surfactant. External surfactants are surfactants that do not become chemically reacted into the polyolefin during preparation of the aqueous dispersion. Examples of external surfactants include, but are not limited to, salts of dodecyl benzene sulfonic acid and lauryl sulfonic acid salt. Internal surfactants are surfactants that do become chemically reacted into the polyolefin during preparation of the aqueous dispersion. Various commercially available surfactants may be used in embodiments disclosed herein, including: OP-100 (a sodium stearate), OPK-1000 (a potassium stearate), and OPK-181 (a potassium oleate), each available from RTD Hallstar; UNICID 350, available from Baker Petrolite; DISPONIL FES 77-IS and DISPONIL TA-430, each available from Cognis; RHODAPEX CO-436, SOPROPHOR 4D384, 3D-33, and 796/P, RHODACAL BX-78 and LDS-22, RHODAFAC RE-610, and RM-710, and SUPRAGIL MNS/90, each available from Rhodia; and TRITON QS-15, TRITON W-30, DOWFAX 2A1, DOWFAX 3B2, DOWFAX 8390, DOWFAX C6L, TRITON X-200, TRITON XN-45S, TRITON H-55, TRITON GR-5M, TRITON BG-10, and TRITON CG-110, each available from The Dow Chemical Company, Midland, Mich.

The aqueous dispersion includes a fluid medium, preferably, water. The aqueous dispersion can comprise 30 weight percent to 85 weight percent of water based on a total weight of the aqueous dispersion; for example the aqueous dispersion can comprise 35 weight percent to 80 weight percent, 40 weight percent to 75 weight percent, or 45 weight percent to 70 weight percent of water based on a total weight of the aqueous dispersion.

In one instance, the non-functional polyolefin (co)polymer comprises between 60 wt % and 98 wt % of the total weight of the solid portion of the aqueous dispersion. In one instance, the non-functional polyolefin (co)polymer comprises between 70 wt % and 95 wt % of the total weight of the solid portion of the aqueous dispersion. In one instance, the non-functional polyolefin (co)polymer comprises between 80 wt % and 90wt % of the total weight of the solid portion of the aqueous dispersion.

In one instance, the modified-polyolefin copolymer comprises between 3 wt % and 35 wt % of the total weight of the solid portion of the aqueous dispersion. All individual values and subranges from 3 to 35 percent by weight of the aqueous dispersion based on the total weight of the solids content of the aqueous dispersion are included herein and disclosed herein; for example, the modified-polyolefin copolymer can be from a lower limit of 3, 4, or 5 percent by weight of the aqueous dispersion based on the total weight of the solids content of the aqueous dispersion to an upper limit of 35, 30, or 16 percent by weight of the aqueous dispersion based on the total weight of the solids content of the aqueous dispersion.

The aqueous dispersion described herein is prepared by melt-kneading the non-functionalized polyolefin(co)polymer, the modified-polyolefin copolymer, the surfactant and the water. Various melt-kneading processes known in the art may be used. In some embodiments, a kneader, a BANBURY® mixer, single-screw extruder, or a multi-screw extruder, e. g. a twin screw extruder, may be utilized. A process for producing the aqueous dispersions in accordance with the present disclosure is not particularly limited. For example, an extruder, in certain embodiments, for example, a twin screw extruder, is coupled to a back pressure regulator, melt pump, or gear pump. Embodiments also provide a base reservoir and an initial water reservoir, each of which includes a pump. Desired amounts of base and initial water can be provided from the base reservoir and the initial water reservoir, respectively. Various suitable pumps may be used, but in some embodiments, for example, a pump that provides a flow of about 150 cc/min at a pressure of 240 bar can be used to provide the base and the initial water to the extruder. In other embodiments, a liquid injection pump provides a flow of 300 cc/min at 200 bar or 600 cc/min at 133 bar. In some embodiments, the base and initial water are preheated in a preheater. For example, in a number of embodiments, one or more non-functional polymers, e. g., in the form of pellets, powder, or flakes, can be fed from the feeder to an inlet of an extruder where the polymers are inched. In some embodiments, a surfactant can be along with the resin and in other embodiments, a surfactant can be provided separately to the extruder. The melted polymers can then be delivered from the mix and convey zone to an emulsification zone of the extruder where an initial amount of water and/or base from the water and base reservoirs can be added through an inlet. In some embodiments, a surfactant may be added additionally or exclusively to the water stream. In some embodiments, further dilution water may be added via water inlet from a water reservoir to a dilution and cooling zone of the extruder. The aqueous dispersion can be diluted, e. g., to at least 30 weight percent water, in the cooling zone. Further dilution may occur a number of times until the desired dilution level is achieved. In some embodiments, water is not added into the twin screw extruder but rather to a stream containing the melt product after the melt product has exited from the extruder. In this manner, steam pressure build-up in the extruder is eliminated and the aqueous dispersion is formed in a secondary mixing device such as a rotor stator mixer.

The average diameter of the solids in the aqueous dispersion is less than 400 nm. In one instance, the average diameter of the solids in the aqueous dispersion is greater than 100 nm. In one instance, the average diameter of the solids in the aqueous dispersion is from 100 to 400 nm. In one instance, the average diameter of the solids in the aqueous dispersion is from 150 to 400 nm. In one instance, the average diameter of the solids in the aqueous dispersion is from 200 to 350 nm.

In one instance, the modified-polyolefin copolymer is neutralized with the neutralizing agent such that the aqueous dispersion has a pH of 5 or greater. In one instance, the pH is no greater than 11. In one instance, the pH is no greater than 10. In one instance, the modified-polyolefin copolymer is neutralized with the neutralizing agent such that the aqueous dispersion has a pH of from 6 to 7.5. In one instance, a buffer solution is added to maintain the pH at the target pH.

In one instance, the aqueous dispersion described herein is used to prepare a composite polymer granule. The shell of the composite polymer granule is defined by a (meth)acrylic (co)polymer. As used herein, the term “(meth)acrylic” means acrylic or methacrylic. (Meth)acrylic monomers used herein include, by way of example, C₁-C₈ (meth)acrylates, such as, butyl acrylate, ethylacrylate, 2-ethyl hexyl acrylate, propyl acrylate, methyl acrylate, hexyl acrylate, butylmethacrylate, methylmethacrylate, ethylhexyl methacrylate, stearyl acrylate, benzyl acrylate, cyclohexyl methacrylate, isobornyl methacrylate, tetrahydrofurfuryl methacrylate, cyclopentyl methacrylate, trifluoroethylmethacrylate, hydroxyethylmethacrylate and dicyclopentadienyl methacrylate and blends thereof, and combinations thereof. The (meth)acrylic monomers may be functionalized, nonfunctionalized or a combination thereof. Exemplary functionalized (meth)acrylic monomers include but not limited to, acrylic acid, methacrylic acid, glycidyl methacrylate, allyl methacrylate, hydroxyethyl methacrylate, and acrylamide.

In one instance, the (meth)acrylic (co)polymer has a T_{g} of less than 50° C. Examples of (meth)acrylic (co)polymers include [butyl acrylate-methylmethacrylate copolymer, ethylhexyl acrylate-methylmethacrylate copolymer, and butyl methacrylate. In one instance, the T_{g} of the shell is from −80° C. to 50° C. In one instance, the T_{g} of the shell is from −50° C. to 45° C. In one instance, the T_{g} of the shell is from −20° C. to 40° C.

The composite polymer granule is defined by a ratio of the combination of the non-functionalized polyolefin (co)polymer and the modified-polyolefin copolymer to (meth)acrylic copolymer of from 20:1 to 1:2 by weight. In one instance, the ratio of the combination of the non-functionalized polyolefin (co)polymer and the modified-polyolefin copolymer to (meth)acrylic copolymer of from 15:1 to 1:1.75. In one instance, the ratio of the combination of the non-functionalized polyolefin (co)polymer and the modified-polyolefin copolymer to (meth)acrylic copolymer of from 10:1 to 1:1.5.

The composite polymer granule defined herein is prepared by the emulsion polymerization of the (meth)acrylic monomer, an initiator, and an aqueous polyolefin seed dispersion comprising a non-functionalized polyolefin (co)polymer, a modified-polyolefin copolymer, water and a surfactant. As is well understood by those skilled in the art, emulsion polymerizations are polymerizations whereby monomer(s), initiator, dispersion medium, and optionally a colloid stabilizer constitute initially an inhomogeneous system resulting in particles of colloidal dimensions containing the formed polymer. In addition, various other optional emulsion polymerization ingredients may be included such as a chelating agent, retarder, buffering agent, inert salt, polymeric emulsifiers/stabilizers, or inhibitor if desired. Frequently the emulsion polymerization process is conducted at temperatures of from 5° to 80° C.

Emulsion polymerization is a process known in the art whereby the (meth)acrylic monomer and the initiator are added to the aqueous dispersion gradually. Emulsion polymerization is contrasted with shot polymerization where the monomer and initiator are added to the aqueous dispersion rapidly. Shot polymerization is ineffective for the process described herein.

The initiator used in the emulsion polymerization is selected to initiate the polymerization of the (meth)acrylic monomers, as is known in the art. Examples of suitable initiators include oxidizing agents, such as hydrogen peroxide, can be employed together with sodium thiosulfate. Water-soluble peroxides are suitable, as are other oxidizing agents such as potassium persulfate, ammonium persulfate, sodium persulfate, alkali metal persulfate, and hydrogen peroxide. The oxidizing agents can be present in an amount of from about 100 ppm to about 5000 ppm by weight based on the weight of the unsaturated monomers. More preferably, the oxidizing agents can be present in an amount of from about 100 ppm to about 2000 ppm by weight based on the weight of the monomers. Depending upon the selection of reaction temperature and the type of monomer chosen the oxidizing agents above can be used as thermal initiators.

The more preferred initiator is tertiary butyl hydrogen peroxide and sodium thiosulfate. The sodium thiosulfate is preferably present in an amount effective to initiate polymerization of the unsaturated monomers. Typically such an amount of sodium thiosulfate is from about 1200 to about 2000 ppm by weight based on the weight of the water-soluble, α,β-ethylenically unsaturated monomers. The amount of total initiators used can range from about 0.01 to about 2 weight percent. Preferably, the amount of total initiators is 0.01 to about 1.0 weight percent based on the weight of the total monomer reactants. In one instance, the polymer composite granule defined herein includes at least partial bonding between the core and the shell. One feature of this partial bonding is that if the shell is extracted using a solvent remnants of the shell will remain intact with the core.

### EXAMPLES

### Materials

ENGAGE™ elastomers (ethylene-octene copolymer), NORDEL™ IP NDR 4820P (ethylene-propylene-diene terpolymer), INFUSE D9807 (ethylene-propylene block copolymer), AFFINITY 1900 (ethylene-octene copolymer), AFFINITY™ GA 1000r (Maleic anhydride grafted ethylene-octene copolymer) were obtained from The Dow Chemical Company, Licocene® PE MA 4351 (maleated PE wax) was obtained from Clariant. EMPICOL® ESB 70 (SLES) was obtained from Huntsman HITENOL BC-10 was obtained from Montello Inc., Calfoam® EA-303 (ALES) was obtained from Pilot Chemical, and Ethoxylated (20 EO) oleic acid, and dodecylbenzenesulfonic (DBS) acid were obtained from Sigma-Aldrich. All acrylic monomers and initiators were purchased from Sigma-Aldrich.

### Preparation of Aqueous Dispersion

An aqueous polyolefin dispersion was prepared utilizing a KWP (Krupp Werner & Pfleiderer Corp. (Ramsey, N.J.)) ZSK25 extruder (25 mm screw diameter, 60 L/D rotating at 450 rpm) according to the following procedure. The base polyolefin resin (an ethylene-octene copolymer, as specified in the Examples, for instance, ENGAGE™ 8200 from Dow Chemical (density=0.87 g/cm3, melt flow index=5 (190° C./2.16 kg), Glass transition temperature (Tg)=−53° C.) and maleated polymer (as specified in the Examples, for instance, LICOCENE PE MA 4351 from Clariant (Muttenz, Switzerland) were supplied to the feed throat of the extruder via a Schenck Mechatron loss-in-weight feeder and a Schenck volumetric feeder, respectively. The polymers were then melt blended, and then emulsified in the presence of initial aqueous stream and a surfactant (as specified in the Examples, for instance, lauryl ether (2EO) sulfate (EMPICOL ESB 70 from Huntsman)) at high pressure. The emulsion phase was then conveyed forward to the dilution and cooling zone of the extruder where additional dilution water was added to form the aqueous dispersions having solid level contents in the range of from less than 70 weight percent, as specified in the examples. The initial aqueous stream, and the dilution water were all supplied by Isco dual syringe pumps (from Teledyne Isco, Inc. (Lincoln, Neb., USA). The barrel temperature of the extruder was set to 150° C. After the dispersion exited the extruder, it was further cooled and filtered via a 200 μm mesh size bag filter. Particle size analysis was done with the Beckman Coulter LS 13 320 Laser Light Scattering Particle Sizer (Beckman Coulter Inc., Fullerton, Calif.). Volume average particle diameter was obtained, as specified in the Examples.

### Preparation of Composite Polymer Dispersion

A polyolefin-acrylic composite polymer granule was produced by seeded emulsion polymerization using the aqueous polyolefin dispersion as a seed to produce according to the following procedure.

The aqueous dispersion prepared as described is diluted to 40 wt % solids with the pH adjusted to 6-8 using a base. The dispersion was then charged into a 250 mL three-neck flask fitted with a condenser and a mechanical stirrer. The flask was placed in a water bath at 65° C. The stirring rod was inserted through the Teflon adaptor and glass sleeve and connected to the center of the flask. The stirrer rate was set at 200 rpm. Nitrogen was slowly purged through the reactor, and cooling water was turned on to flow through the condenser. The acrylic monomers (e.g. MMA, EHA) were mixed with deionized water and Sodium dodecylbenzenesulfonate (SDBS) (0.02 wt % to the monomers) in a glass jar to form a monomer emulsion. The monomer emulsion was fed into the flask by a syringe pump at a steady rate over 60 min formaldehyde sulfoxilate (SFS) and tert-Butyl hydroperoxide (t-BuOOH) (0.3 wt % to the monomers) were dissolved in DI water respectively and then fed by two separate syringe pumps into the reactor at the same rate over 90 min After addition is completed, the dispersion was held at 65° C. for one hour. Finally, the hybrid emulsion was collected by filtration through a 190 micron filter.

### Particle Size Analysis by AFFFF-MALS

The flow regulation of Asymmetrical Flow Field Flow Fractionation (AFFFF) was conducted by Eclipse 3+ (Wyatt Technology, Santa Barbra, Calif.). The separation channel dimensions were 15.2 cm in length and from 2.15 to 0.3 cm in width with a 350 m thickness spacer. Regenerated cellulose membrane with 10 kDa MW cutoff (Wyatt Technology) was used. Flows were delivered with an Agilent Technologies 1200 series isocratic pump equipped with a micro-vacuum degasser. All injections were performed with an auto-sampler (Agilent Technologies 1200 series). Multiple on-line detections were connected in sequential to characterize the fractions separation by AFFFF. The detection train consisted of a variable wavelength ultraviolet/visible spectrophotometer (UV) (SP8480 XR Scanning detector, Spectra-Physics, USA), a multi-angle laser light scattering (MALS) (DAWN HELOS II from Wyatt Technology), and a differential refractometer (RI) (Optilab rEX, from Waytt Technology). Data from UV and MALS detectors were collected and processed by Astra 6.1.2.76 software (Wyatt Technology).

The 90 degree MALS detector was calibrated using HPLC grade toluene (Fisher Scientific). The detectors at other angles were normalized using Narrow PEO standards with MW of 45K from TOSOH BioSciences. The geometric radius of the particle at each elution moment was calculated based on MALS signals at different angles using sphere model. The number, weight and Z averages of particle radius were determine using the number density template in Astra software.

The mobile phase used for AFFFF analysis is 0.1% FL-70 (Fisher Scientific) solution. 20 μl of freshly prepared latex samples were injected into AFFFF system for characterization. Purified water was also injected into the AFFFF system to obtain blank injection signals for UV and RI blank baseline subtraction.

The polyolefin-acrylate dispersion samples were diluted 100-fold using purified water, and filtered through 1 μm glass fiber membrane filter prior to AFFFF analysis. At 40 μL injection volume, the POD particles eluted from AF4 channel are determined to be about 90 wt % of the total sample mass based on sample concentration, injection volume, RI peak area and estimated dn/dc. The dn/dc values were estimated based on the weight fraction and refractive index of each component. The refractive index values of polyolefin and acrylate polymers were measured as 1.506 and 1.474 respectively.

### Morphology Analysis by Atomic-Force Microscopy (AFM)

The polymer dispersion was diluted with MilliQ water, applied on a glass slide and dried at ambient condition. Cross section of the polymer film was prepared by microtome sectioning. Peak force tapping AFM images were obtained on a Bruker Icon using a Nanoscope V controller (software v 8.15). Cantilevers used were Bruker scanasyst air with the following settings: scan sizes 1.25 μm×1.25 μm and 2.5μm×2.5μm. All images were captured at 1024 lines of resolution. All images were produced with SPIP version 6.2.6. software. A 2^{nd} order average plane fit with a zero order LMS and mean set to zero plane fit was used.

### EXAMPLES

The following examples illustrate the present invention but are not intended to limit the scope of the invention.

Four polyolefin dispersions (labeled A-1, A-2, A-3 and A-4) are prepared as described in the “Preparation of aqueous dispersion” section herein, where different type of surfactants were processed under the same conditions, as listed in Table 1. In Table 1, Vₘₑₐₙ refers to the volume-averaged mean particle diameter.

TABLE 1
Formulation of polyolefin dispersions

| | Non-functional | Modified polyolefin | | Vₘₑₐₙ |
|---|---|---|---|---|
| Example | Polyolefin (%) | copolymer (%) | Surfactant (%) | (nm) |
| A-1 | Engage8407 (80) | Licocene 4351 (15) | Empicol ESB (5) | 205 |
| A-2 | Engage8407 (80) | Licocene 4351 (15) | Calfoam EA 303 (5) | 225 |
| A-3 | Engage8407 (80) | Licocene 4351 (15) | Hitenol BC-10 (5) | 225 |
| A-4 | Engage8407 (80) | Licocene 4351 (15) | Empicol:Ethoxylated Oleic | 360 |
| | | | acid (1:1 by weight) (5) | |
| A-5 | Affinity GA1900 | Licocene 4351 (15) | Dodecylbenzenesulfonic | 177 |
| | (80) | | acid, 100% neutralized by | |
| | | | KOH (KDBS) | |

Eight polyolefin dispersions (identified as B-1 through B-8) are prepared with the same surfactants but different resin compositions, as summarized in Table 2. The polyolefin dispersions are prepared as described in the “Preparation of aqueous dispersion” section herein, where the polyolefin, modified polyolefin, surfactants are added in the amounts shown in the parentheses in Table 2 and were processed under the same conditions. Polyolefin dispersions are prepared of <400 nm mean particle diameter with different amount of combined surfactant and modified polyolefin. It is noted that the polyolefin dispersion listed in Table 2 do not include a shell and are used here as a control reference.

TABLE 2
Impact of Licocene and empicol loading on particle size.

| | | Modified | | |
|---|---|---|---|---|
| | Non-functionalized | polyolefin | Surfactant | Vₘₑₐₙ |
| Example | Polyolefin (%) | (wt %) | (wt %) | (nm) |
| B-1 | Engage8407/ | Licocene (9) | Empicol (5) | 358 |
| | Nordel4820 (9:1) (86) | | | |
| B-2 | Engage8407/ | Licocene (12) | Empicol (5) | 271 |
| | Nordel4820 (9:1) (83) | | | |
| B-3 | Engage8407/ | Licocene (15) | Empicol (5) | 225 |
| | Nordel4820 (9:1) (80) | | | |
| B-4 | Engage8407/ | Licocene (15) | Empicol (3) | 393 |
| | Nordel4820 (9:1) (82) | | | |
| B-5 | Engage8407 (88) | Licocene (8) | Empicol (4) | 393 |
| B-6 | Engage8407 (84) | Licocene (12) | Empicol (4) | 358 |
| B-7 | Engage8407 (80) | Licocene (16) | Empicol (4) | 326 |
| B-8 | Engage8407 (76) | Licocene (20) | Empicol (4) | 393 |

### Preparation of Polyolefin-Acrylic Composite Polymer Granule

Eight Polyolefin-acrylic composite polymer granules (identified as C-1 through C-7) were prepared as described in the “Preparation of composite polymer dispersion” section herein, as summarized in Table 3. The pH of all the polyolefin seed dispersions was adjusted to approximately 7.0 using NH₄OH. Different acrylic monomers were used to synthesize the polymer shell, as listed in the “Shell composition” column of Table 3. The core to shell ratio listed in Table 3 is the ratio of the total weight of the monomers in the shell to the weight of the polyolefin solid in the dispersion. Particle size of selected samples were further analyzed as described below.

TABLE 3
Polyolefin-acrylic hybrid particles with a low T_{g} shell

| | | | Core to |
|---|---|---|---|
| Example | POD composition* | Shell composition | shell ratio |
| C-1 | B3 | MMA/BA (3:2) | 100:20 |
| C-2 | 8407/Nordel4820/licocene4351/Empicol | MMA/BA/EGMA (3:2:0.06) | 100:60 |
| C-3 | (72/8/15/5) | MMA/BA (2:3) | 100:60 |
| C-4 | B7: Engage8407/Licocene4351/Empicol | MMA/BA/EHA/MAA | 100:60 |
| | (81/15/4) | (46/46/4/4) | |
| C-5 | A2: | MMA/BA/EHA/MAA | 100:100 |
| | Engage8407/Nordel4820/Licocene4351/ | (20/70/8/2) | |
| C-6 | ALES (72/8/15/5) | MMA/BA/EHA/MAA | 100:60 |
| | | (48/46/4/2) | |
| C-7 | A3 | MMA/BA/EHA/MAA | 100:60 |
| | Engage8407/Nordel4820/Licocene4351/ | (48/46/4/2) | |
| | Hitenol BC-10 (72/8/15/5) | | |
| C-8 | A5 | MMA/EHA/MAA (59/36/5) | 100:150 |
| | Affinity1900/Licocene4351/KDBS | | |
| | (80/15/5) | | |

AFM tapping mode image, calculated as described in the “Morphology analysis by Atomic-force microscopy (AFM)” section, shows the stiffness contrast of crystal domains on the polyolefin particle surface. For sample C-1, the acrylic domains are in the range of 20-100 nm. Besides, the acrylic domains seem to preferably reside in the amorphous phase of the polyolefin particles. By increasing the acrylic polymer loading, as evident by sample C-2, more complete surface coverage by the acrylic particles was achieved based on a qualitative review of the image stiffness contrast image generated by AFM characterization procedure.

One polyolefin dispersion (B-3 in Table 2) and their corresponding hybrid particles (C-1 and C-2 as described in Table 3) were analyzed using the Asymmetric Flow Field Flow Fractionation-Multi-angle Light Scattering (AFFFF-MALS) technique as described above. The detected corresponding particle radii after emulsion polymerization are in the same range as the POD seed, but the main peaks and the size averages are shifted to larger size. This technique can distinguish particles with a difference of several nm in radius. Rₙ, R_{w} and R_{z} are number, weight and Z-averages of particle radius, respectively. The results of this analysis for three samples are listed in Table 4.

TABLE 4
Summary of POD and polyolefin-acrylic particle size

| | Rₙ (nm) | R_{w} (nm) | R_{z} (nm) |
|---|---|---|---|
| B-3 | 101.6 | 107.5 | 113.0 |
| C-1 | 103.9 | 110.2 | 115.7 |
| C-2 | 111.6 | 117.6 | 123.7 |

1. A method for preparing an aqueous dispersion, the method comprising:
(a) melt-kneading a non-functionalized polyolefin (co)polymer, a modified-polyolefin copolymer, a surfactant and water to provide an aqueous dispersion, the average diameter of solids in the aqueous dispersion are less than 400 nm; and
(b) neutralizing the aqueous dispersion with a base to a pH of 5 or greater.

2. The method for preparing an aqueous dispersion of claim 1, wherein, the non-functionalized polyolefin (co)polymer comprises between 60 wt % and 98 wt % of the total weight of the solid portion of the aqueous dispersion, and the modified-polyolefin copolymer comprises between 3 wt % and 35 wt % of the total weight of the solid portion of the aqueous dispersion.

3. A method for preparing a composite polymer granule, the method comprising:
(a) providing the aqueous dispersion prepared in claim 1;
(b) combining a (meth)acrylic monomer and an initiator with the aqueous dispersion under emulsion polymerization conditions, the (meth)acrylic monomer is added such that a ratio of the combination of the non-functionalized polyolefin (co)polymer and the modified-polyolefin copolymer to the (meth)acrylic monomer is from 20:1 to 1:2 by weight.

4. A composite polymer granule comprising:
a core defined by a non-functionalized polyolefin (co)polymer and a modified polyolefin copolymer, wherein the modified-polyolefin copolymer includes, in polymerized form, monomer units selected from acidic monomers and olefinic monomers wherein the ratio of acidic monomers to olefinic monomers is from 0.5 wt % to 20 wt %;
a shell defined by a (meth)acrylic copolymer having a T_{g} of less than 50° C.; and
wherein the ratio of the combination of the non-functionalized polyolefin (co)polymer and the modified-polyolefin copolymer to (meth)acrylic copolymer is from 20:1 to 1:2 by weight.

5. The composite polymer granule of claim 4, wherein, the non-functionalized polyolefin (co)polymer comprises between 60 wt % and 98 wt % of the total weight of the solid portion of the aqueous dispersion, and the modified-polyolefin copolymer comprises between 3 wt % and 35 wt % of the total weight of the solid portion of the aqueous dispersion.

6. The composite polymer granule of claim 4, wherein, the T_{g} is from −80° C. to 50° C.

7. The composite polymer granule of claim 4, wherein the acidic monomers comprise unsaturated cyclic anhydrides and their aliphatic diesters, and the diacid derivatives.

8. The composite polymer granule of claim 4 wherein the core is at least partially bonded to the shell.
